(19) United States
(12) Patent Application Publication
(10) Pub. No.: US 2025/0173247 A1
(43) Pub. Date: May 29, 2025

(54) AUTOMATED DATASET TESTING FOR APPLICATIONS

(71) Applicant: Capital One Services, LLC, McLean, VA (US)

(72) Inventor: Raymond URCIUOLI, Orlando, FL (US)

(21) Appl. No.: 18/519,688

(22) Filed: Nov. 27, 2023

(51) Int. Cl. G06F 11/36

(52) U.S. Cl. CPC G06F 11/3684; G06F 11/3688; G06F 11/3692

(57) ABSTRACT

In some implementations, a data test system may receive information identifying an application for testing, wherein the application includes a dataset processing component that receives an input dataset and generates an actual output dataset. The data test system may identify an expected output dataset for the application, wherein the expected output dataset is derived separately from the input dataset and is derived separately from a functionality of the dataset processing component. The data test system may execute the application on the input dataset to generate the actual output dataset. The data test system may generate a data characterization comparing the actual output dataset and the expected output dataset. The data test system may determine whether the data characterization passes the application and the input dataset for deployment. The data test system may transmit information indicating whether the data characterization passes the application and input dataset for deployment.

### BACKGROUND

Software testing, which is a fundamental process in a software development lifecycle, involves systematically evaluating software applications to ensure that functionality and performance of the software applications align with specified requirements. This software testing process can include multiple stages, such as unit testing, integration testing, and system testing. In each stage, a set of test cases can be configured and executed to assess a behavior of a software application under both common and uncommon conditions, thereby enabling an identification of defects and inconsistencies in a codebase. Through a systematic evaluation, software testing can validate an accuracy and reliability of a software application, thereby reducing a likelihood of post-deployment issues.

### SUMMARY

Some implementations described herein relate to a system for dataset-based application testing. The system may include one or more memories and one or more processors communicatively coupled to the one or more memories. The one or more processors may be configured to receive information identifying an application for testing, wherein the application includes a dataset processing component that receives an input dataset and generates an actual output dataset. The one or more processors may be configured to identify an expected output dataset for the application, wherein the expected output dataset is derived separately from the input dataset and is derived separately from a functionality of the dataset processing component. The one or more processors may be configured to execute the application on the input dataset to generate the actual output dataset. The one or more processors may be configured to generate a data characterization comparing the actual output dataset and the expected output dataset with respect to a set of metrics. The one or more processors may be configured to determine that the data characterization passes the application and the input dataset for deployment. The one or more processors may be configured to cause the application to be deployed to a deployment environment based on the data characterization passing the application and the input dataset for deployment.

Some implementations described herein relate to a method for dataset-based application testing. The method may include receiving, by a data test system, information identifying an application for testing, wherein the application includes a dataset processing component that receives an input dataset and generates an actual output dataset. The method may include identifying, by the data test system, an expected output dataset for the application, wherein the expected output dataset is derived separately from the input dataset and is derived separately from a functionality of the dataset processing component. The method may include executing, by the data test system, the application on the input dataset to generate the actual output dataset. The method may include generating, by the data test system, a data characterization comparing the actual output dataset and the expected output dataset with respect to a set of metrics. The method may include determining, by the data test system, whether the data characterization passes the application and the input dataset for deployment. The method may include transmitting, by the data test system, information indicating whether the data characterization passes the application and input dataset for deployment.

Some implementations described herein relate to a non-transitory computer-readable medium that stores a set of instructions. The set of instructions, when executed by one or more processors of a system, may cause the system to receive information identifying an application for testing, wherein the application includes a dataset processing component that receives an input dataset and generates an actual output dataset. The set of instructions, when executed by one or more processors of the system, may cause the system to identify an expected output dataset for the application, wherein the expected output dataset is derived separately from the input dataset and is derived separately from a functionality of the dataset processing component. The set of instructions, when executed by one or more processors of the system, may cause the system to execute the application on the input dataset to generate the actual output dataset. The set of instructions, when executed by one or more processors of the system, may cause the system to generate a data characterization comparing the actual output dataset and the expected output dataset with respect to a set of metrics. The set of instructions, when executed by one or more processors of the system, may cause the system to determine whether the data characterization passes the application and the input dataset for deployment. The set of instructions, when executed by one or more processors of the system, may cause the system to selectively perform a deployment action on the application based on whether the data characterization passes the application and the input dataset for deployment.

### BRIEF DESCRIPTION OF THE DRAWINGS

FIGS. 1A-1D are diagrams of an example implementation associated with automated dataset testing for applications, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with automated dataset testing for applications, in accordance with some embodiments of the present disclosure.

FIG. 4 is a flowchart of an example process associated with automated dataset testing for applications, in accordance with some embodiments of the present disclosure.

### DETAILED DESCRIPTION

The following detailed description of example implementations refers to the accompanying drawings. The same reference numbers in different drawings may identify the same or similar elements.

Software application testing is used to ensure that deployed applications are error-free. To perform software application testing, a set of test cases may be configured and executed to determine a behavior of the application in response to various possible user use cases. As a quantity of connections between different systems increases, a complexity of the application testing increases accordingly. When test cases are configured, the test cases may be designed to check for a particular behavior. For example, a test case may be configured to determine whether, when an element is added to a list within the application, the element is successfully added at the front of the list. In this case, when the test requests an output from the front of the list and the output matches the element that was added to the list, the test can be declared a success. This type of test may be referred to as an application-based test or a functionality-based test, as the test is directed to a function of the application.

However, such application tests may return positive results even when the application has an incorrect functionality, which is not being tested for. In other words, if the application erroneously deletes the existing list and creates a new list for the added element, the application will successfully return the added element when returning the front of the list. In this case, however, the application is operating incorrectly by deleting the existing list, rather than adding the element to the front of the list. Accordingly, application-based testing can be error prone when there are many possible ways to successfully pass a test with erroneous functionality.

Some implementations described herein perform dataset-based application testing. In dataset-based application testing, the application under test is treated as a black box subsystem that receives a dataset input and generates an output dataset. In this case, a data test system may receive an input dataset for an application and an expected output dataset. The data test system may execute the application using the input dataset and generate an actual output dataset that the data test system can compare with the expected output dataset. In this case, the data test system may characterize the actual output dataset relative to the expected output dataset using one or more characterization metrics and determine whether to declare a successful test. Based on declaring a successful test, the data test system may deploy the application to a deployment environment.

In this way, the data test system enables dataset-based application testing. By performing dataset-based application testing, rather than functionality-based application testing, the data test system may reduce a test complexity for increasingly complex systems. For example, in dataset-based application testing, increasing connections between an application and other components may not increase a test complexity when a relationship between an input dataset and an output dataset remains the same. In other words, in functionality-based testing, adding a new set of application programming interface (API) calls may necessitate a new set of tests executed on the API calls added to an existing set of tests for the application, whereas in dataset-based testing, the existing set of tests for the application can be used without modification when adding the new set of API calls does not change the relationship between an input dataset and an output dataset (e.g., the new set of API calls, for example, changes a manner of generating the output dataset, but not the actual content of the output dataset). By reducing a testing complexity for application testing, some implementations described herein reduce a computing resource utilization associated with application testing.

Furthermore, by enabling dataset-based application testing, the data test system reduces a likelihood of missed error cases as a result of incomplete functionality testing. For example, by testing a relationship between input datasets and output datasets, the data test system can increase a coverage of a set of test cases relative to functionality testing cases. As an example, a dataset-based application test, executed by the data test system, may test for the dataset to which the abovementioned element is added and compare the dataset to an expected dataset, thereby ensuring that the underlying functionality achieves the correct goal (e.g., adding the new element to the front of the list) rather than passing a test with incorrect functionality, as described above.

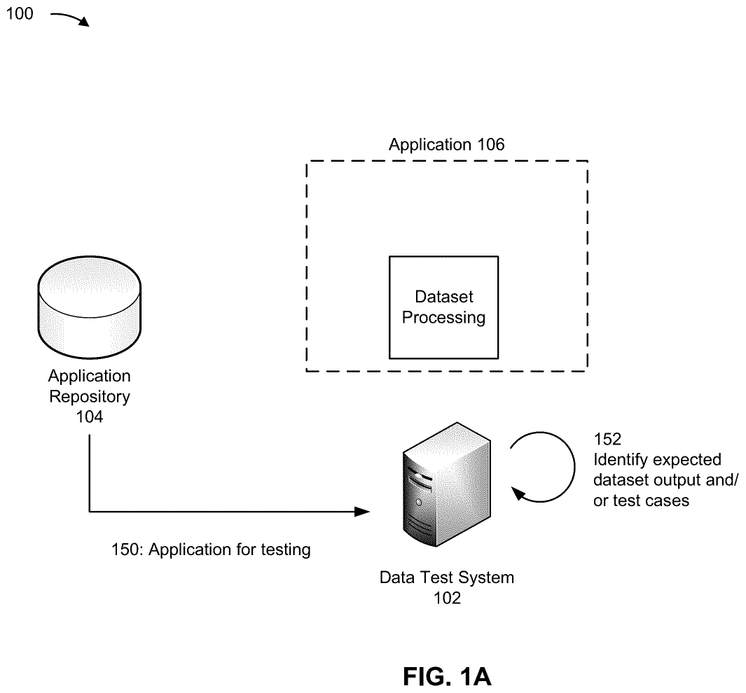

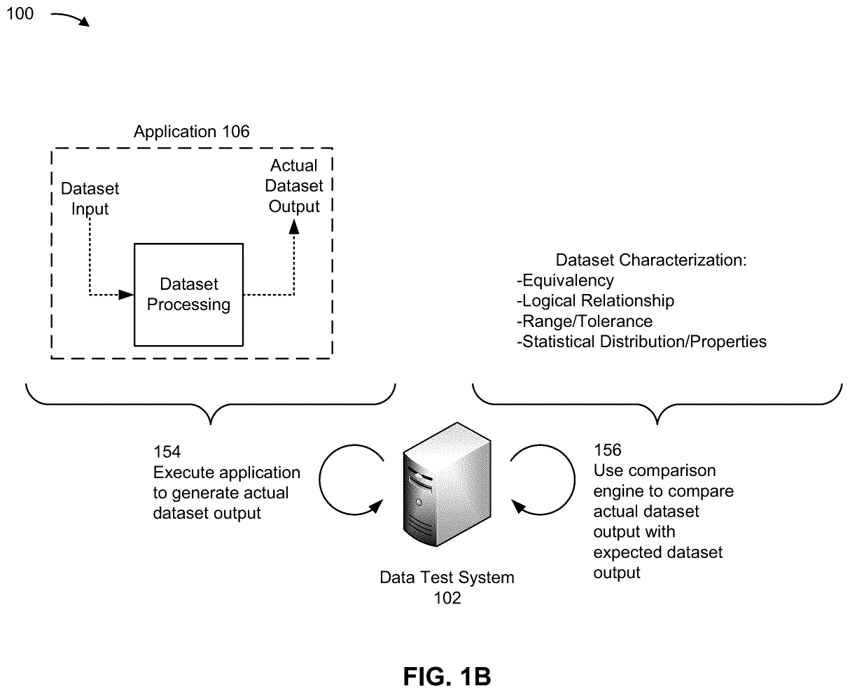

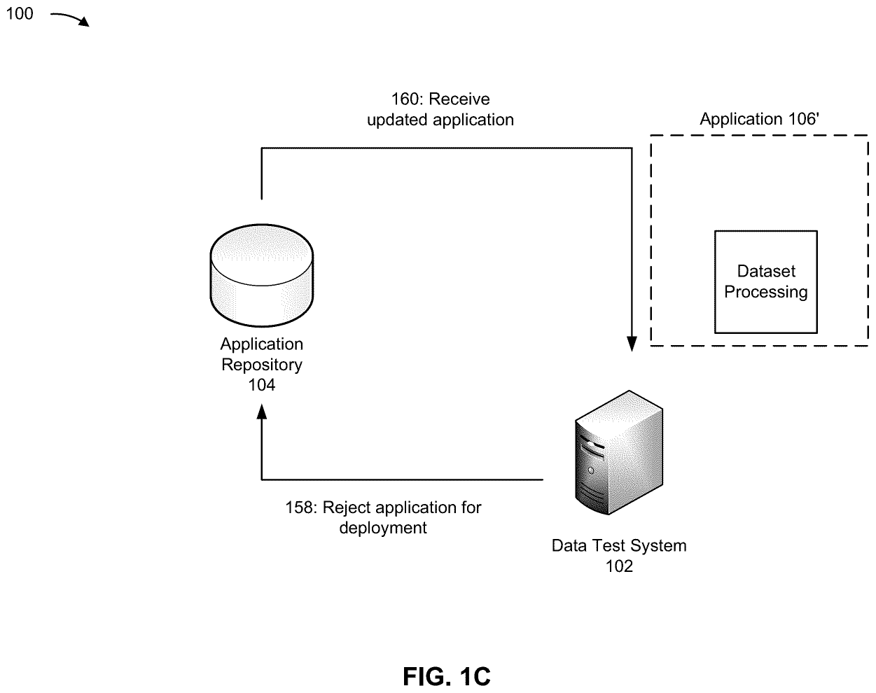

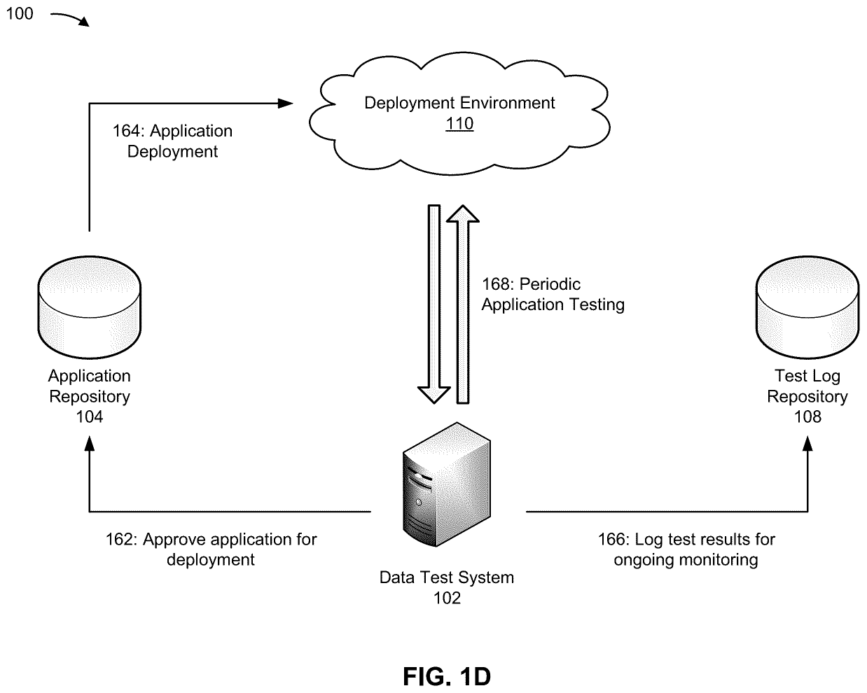

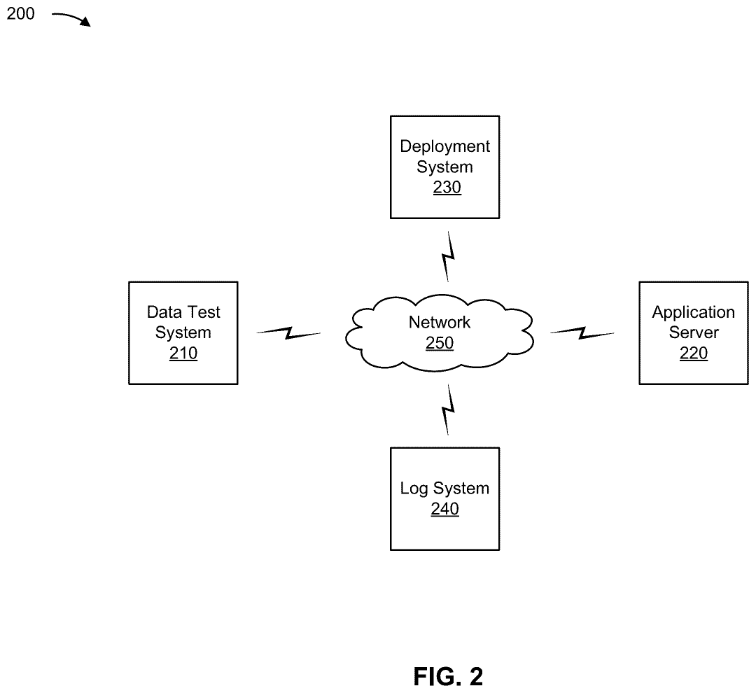

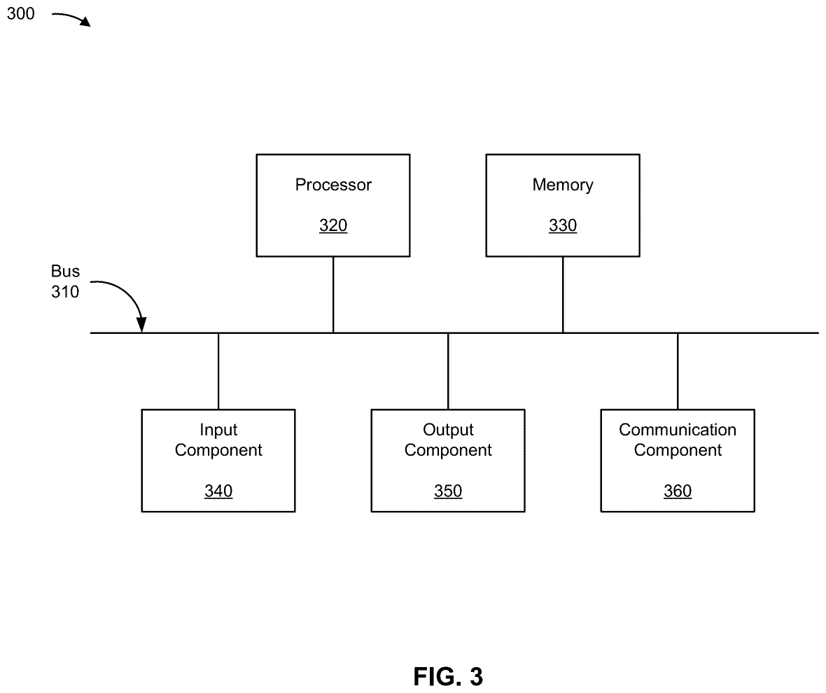

FIGS. 1A-1D are diagrams of an example implementation 100 associated with automated dataset testing for applications. As shown in FIGS. 1A-1D, example implementation 100 includes a data test system 102, an application repository 104, a test log repository 108, and a deployment environment 110. These devices are described in more detail below in connection with FIG. 2 and FIG. 3.

As shown in FIG. 1A, and by reference number 150, the data test system 102 may receive an application for testing. For example, the data test system 102 may receive the application 106, which includes a procedure for processing a dataset. In some implementations, the application 106 may include a processing component. For example, the data test system 102 may receive the application 106 to test whether the application 106 generates an output, as a result of receiving an input, that is a match with an expected output, as described in more detail below.

As further shown in FIG. 1A, and by reference number 152, the data test system 102 may identify an expected output dataset and/or a test case for an application. For example, the data test system 102 may identify the expected output dataset of application 106 when a particular input is provided to the application 106. In some implementations, the data test system 102 may identify a mapping of one or more inputs to one or more outputs in connection with identifying an expected output dataset. For example, the data test system 102 may identify a one-to-one mapping of an input dataset to an output dataset and may identify, generate, or receive an expected output dataset for each input dataset that the data test system 102 is to test using the application 106. Additionally, or alternatively, the data test system 102 may identify a many-to-one mapping of input datasets to output datasets and may identify, generate, or receive an expected output dataset for each group of multiple input datasets. Additionally, or alternatively, the data test system 102 may identify a many-to-many mapping of input datasets to output datasets and may identify, generate, or receive, multiple expected output datasets for each group of multiple input datasets. Additionally, or alternatively, the data test system 102 may identify a one-to-many mapping of input datasets to output datasets and may identify, generate, or receive multiple excepted output datasets for each input dataset that the data test system 102 is to test using the application 106.

In some implementations, the data test system 102 may identify an input dataset for a multi-step process or a multi-application test. For example, for a multi-application test, the data test system 102 may generate one or more input datasets for executing multiple applications (e.g., concurrently) that provide one or more output datasets. Additionally, or alternatively, for multi-step processes, the data test system 102 may generate an input dataset that is input to a first application, whose output is input to a second application that has an output for comparison to the expected output dataset.

In some implementations, the data test system 102 may identify an input dataset for which to identify an expected output dataset. For example, the data test system 102 may receive information identifying an input dataset and an expected output dataset. Additionally, or alternatively, the data test system 102 may receive information identifying an input dataset and one or more logic rules for generating an output dataset. For example, the data test system 102 may receive information identifying an input dataset and may use an application 106* (not shown) to generate an expected output dataset for the application 106.

In this example, the application 106* may represent a version of the application 106 that executed in a different type of execution environment, using a different set of execution resources (e.g., different application programming interfaces), or is a less efficient version of the application 106, among other examples. In other words, the data test system 102 may receive an existing application, which is determined to be working but not suitable for a particular purpose (e.g., deployment on a particular type of device, use of a particular set of APIs, inefficient, or another reason why the existing application may not be preferred), and use the existing application to generate an expected output dataset for a new application, which is set for testing. In this way, an existing application, such as a first version of an application that can execute on a first operating system, can be used to generate expected output data for a second version of the application that can execute on a second operating system. Similarly, an existing application, which may have a first level of resource efficiency, can be used to generate expected output data for a new version of the existing application, which may have a second, higher level of resource efficiency.

In some implementations, the data test system 102 may identify a particular type of input dataset. For example, the data test system 102 may receive, determine, or generate an input dataset using a real set of values. For example, the data test system 102 may access one or more databases or other data structures that the application 106 is to access and may obtain, as the input dataset, values that the application 106 is to use. Additionally, or alternatively, the data test system 102 may generate synthetic or artificial data for the input dataset. For example, the data test system 102 may anonymize existing data or extrapolate existing data using one or more synthetic or artificial data generation techniques to generate a dataset that can be used as the input dataset. In this way, the data test system 102 can identify an input dataset of a threshold size from a small quantity of real values and/or without exposing protected information. Additionally, or alternatively, the data test system 102 may receive, determine, or generate one or more outlier values (e.g., for inclusion in the input dataset or as the input dataset) associated with a set of test cases. For example, the data test system 102 may identify one or more test case scenarios for the application 106 (e.g., a null dataset when the application 106 is expecting a dataset with values, a dataset with values of a wrong type or magnitude, a dataset with a magnitude of entries that is larger than expected, etc.) to test whether the application 106 handles the one or more test cases associated with the one or more outlier values.

In some implementations, the data test system 102 may derive the expected output dataset separately from the input dataset and/or a functionality of the application 106 and a dataset processing component thereof. For example, the data test system 102 may generate the expected output dataset using a different application than (or different version of) the application 106. In other words, the expected output dataset may not be generated using the application 106. Additionally, or alternatively, the data test system 102 may generate the expected output dataset without using the input dataset. For example, the data test system 102 may use a data generation component that generates the input dataset and the expected output dataset using separate processes, functionalities, or program code (e.g., without the input dataset being an input to the expected output dataset). In some implementations, the data test system 102 may generate the input dataset from the expected output dataset.

As shown in FIG. 1B, and by reference number 154, the data test system 102 may execute an application to generate an actual output dataset. For example, the data test system 102 may execute the application 106 on a particular dataset input to generate an actual output dataset from the application 106. In this case, the data test system 102 may execute the application 106 a single time using a single input dataset, multiple times using multiple input datasets, or in multiple phases (e.g., when the application 106 includes multiple input/output steps or includes multiple sub-applications 106), among other examples.

As further shown in FIG. 1B, and by reference number 156, the data test system 102 may use a comparison engine to compare the actual output dataset with the expected output dataset. For example, the data test system 102 may characterize the actual output dataset with respect to the expected output dataset. In this case, the characterization may be related to one or more types or classes of characterization, such as a level of equivalency between the actual output dataset and the expected output dataset, a logical relationship between the actual output dataset and the expected output dataset, a range or tolerance of values of the actual output dataset relative to the expected output dataset, or a statistical distribution or statistical property of the expected output dataset relative to the actual output dataset.

In some implementations, the data test system 102 may generate the data characterization based on an equivalency between the expected output dataset and the actual output dataset. For example, the data test system 102 may determine that a characteristic of the expected output dataset (e.g., a set of values, a size, a statistical profile, or another characteristic) is equivalent to the actual output dataset. In this case, the characteristic may be equivalent to within a threshold degree. For example, the data test system 102 may be configured such that equivalency can include statistical profiles that are within a threshold amount of each other. As an example, when the application 106 is configured to generate an output dataset of semi-random values with a particular standard deviation from a mean value, the data test system 102 may determine an equivalency when the particular standard deviation of the actual output dataset is within a configured percentage of the particular standard deviation of the expected output dataset.

Additionally, or alternatively, the data test system 102 may generate the data characterization based on a logical relationship between the expected output dataset and the actual output dataset. For example, the data test system 102 may generate the data characterization based on whether a configured logical relationship exists between the input dataset and the actual output dataset that corresponds to a logical relationship between the input dataset and an expected output dataset. Additionally, or alternatively, the data test system 102 may generate the data characterization based on a range of values. For example, the actual output dataset may be characterized as passing a test relative to the expected output dataset when values of the actual output dataset are within a configured range or within a configured range or tolerance of values of the expected output dataset.

Additionally, or alternatively, the data test system 102 may generate the data characterization based on a statistical distribution. For example, the data test system 102 may determine that a statistical distribution of values in the expected output dataset shares one or more characteristics in common with a statistical distribution of values in an actual output dataset. As a particular example, when the application 106 is configured to generate synthetic data or artificial data based on an input population, the expected output dataset may be an actual population dataset (e.g., actual health data) and the actual output dataset may be a generated synthetic dataset or artificial dataset (e.g., that preserves patient anonymity). In this case, the data test system 102 may determine that the actual output dataset passes a test based on one or more statistical distributions in the actual output dataset matching one or more statistical distributions in the expected output dataset (e.g., artificially generated patients having approximately the same distribution of ages, vital stats, patient histories, etc.). In this case, the data test system 102 may calculate a first statistical distribution of one or more attributes of real patients in the expected output dataset and a second statistical distribution of one or more attributes of artificial patients in the actual output dataset to determine whether the first statistical distribution matches the second statistical distribution (e.g., to within a configured degree).

In some implementations, the data test system 102 may characterize results from multiple steps of testing. For example, the data test system 102 may execute a multi-step application that has an intermediate output dataset, which is an output from a first step and an input to a second step. In this case, the data test system 102 may compare the intermediate actual output dataset to an intermediate expected output dataset and a final actual output dataset (e.g., which may be generated using the intermediate actual output dataset or the intermediate expected output dataset) to a final expected output dataset.

As shown in FIG. 1C, and by reference number 158, the data test system 102 may reject an application for deployment. For example, the data test system 102 may reject the application 106 based on the data characterization of the application 106 not passing the application 106 for deployment. In some implementations, the data test system 102 may transmit an indication of an error associated with the application or the input dataset. For example, the data test system 102 may transmit, to the application repository 104 or a development system that includes a user interface for developing the application 106, an indication of an error in testing the application 106. Additionally, or alternatively, the data test system 102 may transmit a recommendation for the application 106. For example, the data test system 102 may identify a factor of the characterization of the actual output dataset that resulted in the actual output dataset not passing the test. In this case, the data test system 102 may indicate the factor and/or a recommendation for modifying the application 106 to correct the application 106. In some implementations, the data test system 102 may parse program code of the application 106 to determine the recommendation. For example, the data test system 102 may train and/or store a machine learning model for parsing program code and generating recommendations for fixing the program code based on results of executing a test on the data test system 102.

As further shown in FIG. 1C, and by reference number 160, the data test system 102 may receive an updated application. For example, the data test system 102 may receive an application 106′ that is an update of the application 106. In this case, the updated application 106′ may include one or more modifications to alter a behavior of the updated application 106′. In some implementations, the data test system 102 may execute one or more tests on the updated application 106′. For example, the data test system 102 may execute the updated application 106′ on the input dataset (or a new input dataset). In some implementations, the data test system 102 may forgo executing the application 106′ on one or more datasets that the application 106 passed. For example, when the application 106 passes a first one or more tests associated with a first one or more input datasets and fails a second one or more tests associated with a second one or more input datasets, the data test system 102 may test the application 106′ on only the second one or more tests to reduce a quantity of tests that are executed, thereby conserving computing resources.

In some implementations, the data test system 102 may use a machine learning model to determine whether to forgo some tests. For example, the data test system 102 may determine relationships between different tests and may determine whether modifications to fix results of a first test implicate functionality of a second test and may use the determination to determine whether to execute both the first test and the second test or only the first test. Additionally, or alternatively, the data test system 102 may treat the updated application 106′ as a black box and re-execute each test regardless of results of executing each test on the application 106. This may reduce processing complexity and/or computing resource utilization associated with determining which tests to run.

Based on running tests on the updated application 106′, the data test system 102 may re-characterize the updated application 106′ and the input datasets based on receiving the update. For example, the data test system 102 may generate a new characterization of the updated application 106′, which may result in the updated application 106′ passing tests associated with input datasets, rather than failing as the application 106 failed. In this case, the data test system 102 may transmit a new alert (e.g., indicating that the updated application 106′ passed the tests). Alternatively, when the updated application 106′ fails the tests, the data test system 102 may transmit a failure or error alert and may receive another update to the application 106 (e.g., a further updated application 106″ (not shown) for further testing.

As shown in FIG. 1D, and by reference number 162, the data test system 102 may approve an application for deployment. For example, the data test system 102 may approve the application 106 (or the application 106′) based on a data characterization of the application 106 (or the application 106′) passing the application 106 (or the application 106′) for deployment. In this case, the data test system 102 may transmit an alert indicating that the application passes one or more tests associated with the data characterization and, for example, is approved for deployment. Additionally, or alternatively, the data test system 102 may transmit an alert that the one or more tests are passed to approve the application 106 for another purpose, such as for a further phase of development or a further phase of testing, among other examples.

As further shown in FIG. 1D, and by reference number 164, the data test system 102 may cause an application to be deployed. For example, the data test system 102 may cause the application 106 to be deployed based on passing the application 106. In some implementations, the data test system 102 may transmit information to the deployment environment 110 to cause the application 106 to be deployed. For example, the data test system 102 may cause the deployment environment 110 to allocate resources to the application 106, to make the application 106 available via an API or web page, or to provide a user interface notification that the application 106 is available.

As further shown in FIG. 1D, and by reference number 166, the data test system 102 may log test results for ongoing monitoring. For example, the data test system 102 may transmit information identifying a result of testing the application 106 to the test log repository 108 for storage. In some implementations, the data test system 102 may log test results based on executing a test. For example, when the data test system 102 executes the application 106 to generate the actual output dataset and generates the data characterization, the data test system 102 may log the actual output dataset and/or the data characterization in the test log repository 108. In this case, the data test system 102 may use the test log repository 108 for comparing results of different testing iterations, training a machine learning model (e.g., to analyze subsequent tests or generate recommendations), or for manual debugging (e.g., by making test logs of the test log repository 108 available via an API or web page).

As further shown in FIG. 1D, and by reference number 168, the data test system 102 may perform periodic testing of an application. For example, the data test system 102 may communicate with the deployment environment 110 to perform ongoing testing on the application 106 and compare results of the ongoing testing to logged test data stored in the test log repository 108. In some implementations, the data test system 102 may perform event-based testing. For example, the data test system 102 may detect an event when monitoring operation of the application 106 after deployment, such as an error occurring, a resource utilization exceeding a threshold, a user submitting a trouble ticket, or another type of event. In this case, the data test system 102 may analyze results of executing the application 106 relating to the event or may execute one or more tests (e.g., using one or more input datasets) on the application 106 to determine whether the application 106 is functioning properly or whether an error has occurred. Based on results of the testing, the data test system 102 may compare results of the testing with logged test results in the test log repository 108 and perform an application management action. For example, the data test system 102 may transmit an alert, remove the application 106 from deployment, generate new program code to fix an error, replace the application 106 with a different version of the application 106 (or with a different application), or automatically resolve a trouble ticket, among other examples.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

FIG. 2 is a diagram of an example environment 200 in which systems and/or methods described herein may be implemented. As shown in FIG. 2, environment 200 may include a data test system 210, an application server 220, a deployment system 230, a log system 240, and a network 250. Devices of environment 200 may interconnect via wired connections, wireless connections, or a combination of wired and wireless connections.

The data test system 210 may include one or more devices capable of receiving, generating, storing, processing, providing, and/or routing information associated with dataset-based application testing, as described elsewhere herein. For example, the data test system 210 may include computing resources that execute one or more tests on an application. The data test system 210 may correspond to the data test system 102 described with regard to FIGS. 1A-1D. The data test system 210 may include a communication device and/or a computing device. For example, the data test system 210 may include a server, such as an application server, a client server, a web server, a database server, a host server, a proxy server, a virtual server (e.g., executing on computing hardware), or a server in a cloud computing system. In some implementations, the data test system 210 may include computing hardware used in a cloud computing environment.

The application server 220 may include one or more devices capable of receiving, generating, storing, processing, and/or providing information associated with an application, as described elsewhere herein. For example, the application server 220 may include a testing environment in which software is developed or a repository that stores applications that are to be tested. The application server 220 may correspond to the application repository 104 described with regard to FIGS. 1A-1D. The application server 220 may include a communication device and/or a computing device. For example, the application server 220 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The application server 220 may communicate with one or more other devices of environment 200, as described elsewhere herein.

The deployment system 230 may include one or more devices capable of receiving, generating, storing, processing, providing, and/or routing information associated with application, as described elsewhere herein. For example, the deployment system 230 may include one or more computing resources of a deployment environment to which applications are deployed after successful application testing. The deployment system 230 may correspond to the deployment environment 110 described with regard to FIGS. 1A-1D. The deployment system 230 may include a communication device and/or a computing device. For example, the deployment system 230 may include a server, such as an application server, a client server, a web server, a database server, a host server, a proxy server, a virtual server (e.g., executing on computing hardware), or a server in a cloud computing system. In some implementations, the deployment system 230 may include computing hardware used in a cloud computing environment.

The log system 240 may include one or more devices capable of receiving, generating, storing, processing, and/or providing information associated with a test log, as described elsewhere herein. The log system 240 may correspond to the test log repository 108 described with regard to FIGS. 1A-1D. The log system 240 may include a communication device and/or a computing device. For example, the log system 240 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the log system 240 may store results of a set of dataset tests performed on a set of applications, as described elsewhere herein.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with automated dataset testing for applications. The device 300 may correspond to data test system 210, application server 220, deployment system 230, and/or log system 240. In some implementations, data test system 210, application server 220, deployment system 230, and/or log system 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

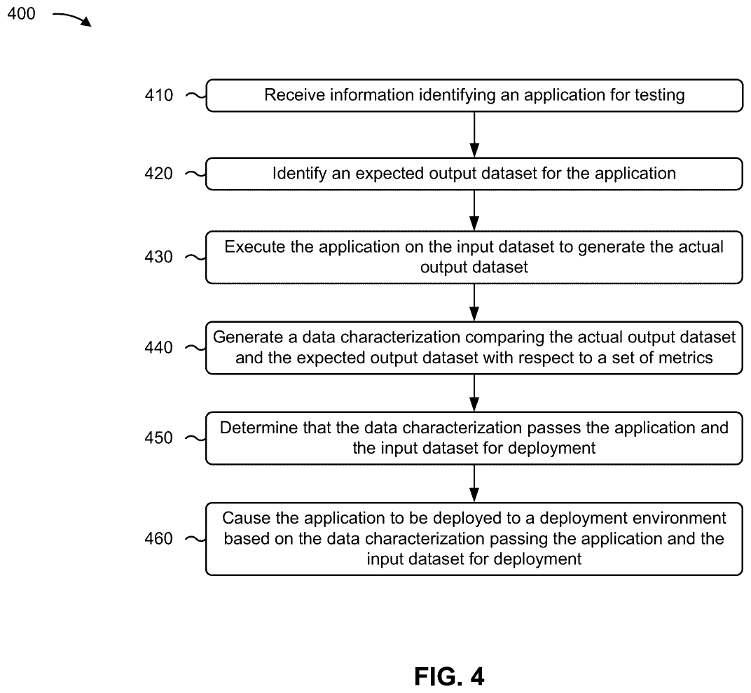

FIG. 4 is a flowchart of an example process 400 associated with automated dataset testing for applications. In some implementations, one or more process blocks of FIG. 4 may be performed by the data test system 210. In some implementations, one or more process blocks of FIG. 4 may be performed by another device or a group of devices separate from or including the data test system 210, such as the application server 220, the deployment system 230, and/or the log system 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving information identifying an application for testing (block 410). For example, the data test system 210 (e.g., using processor 320, memory 330, input component 340, and/or communication component 360) may receive information identifying an application for testing, as described above in connection with reference number 150 of FIG. 1A. As an example, the data test system 210 may receive an application from an application repository, which stores one or more applications that are to be tested. In some implementations, the application includes a dataset processing component that receives an input dataset and generates an actual output dataset.

As further shown in FIG. 4, process 400 may include identifying an expected output dataset for the application (block 420). For example, the data test system 210 (e.g., using processor 320 and/or memory 330) may identify an expected output dataset for the application, as described above in connection with reference number 152 of FIG. 1A. As an example, the data test system 210 may use a data process logic to generate an expected output dataset. In some implementations, the expected output dataset is derived separately from the input dataset and is derived separately from a functionality of the dataset processing component.

As further shown in FIG. 4, process 400 may include executing the application on the input dataset to generate the actual output dataset (block 430). For example, the data test system 210 (e.g., using processor 320 and/or memory 330) may execute the application on the input dataset to generate the actual output dataset, as described above in connection with reference number 154 of FIG. 1B. As an example, the data test system 210 may execute the application with the input dataset as an input to the application and cause the application to generate an actual output dataset.

As further shown in FIG. 4, process 400 may include generating a data characterization comparing the actual output dataset and the expected output dataset with respect to a set of metrics (block 440). For example, the data test system 210 (e.g., using processor 320 and/or memory 330) may generate a data characterization comparing the actual output dataset and the expected output dataset with respect to a set of metrics, as described above in connection with reference number 156 of FIG. 1B. As an example, the data test system 210 may characterize the actual output dataset and the expected output dataset with respect to an equivalency factor, a logical relationship factor, a range or tolerance factor, or a statistical distribution or statistical property factor, among other examples.

As further shown in FIG. 4, process 400 may include determining that the data characterization passes the application and the input dataset for deployment (block 450). For example, the data test system 210 (e.g., using processor 320 and/or memory 330) may determine that the data characterization passes the application and the input dataset for deployment, as described above in connection with reference number 162 of FIG. 1D. As an example, the data test system 210 may determine that one or more metrics associated with the data characterization satisfy one or more corresponding threshold values.

As further shown in FIG. 4, process 400 may include causing the application to be deployed to a deployment environment based on the data characterization passing the application and the input dataset for deployment (block 460). For example, the data test system 210 (e.g., using processor 320 and/or memory 330) may cause the application to be deployed to a deployment environment based on the data characterization passing the application and the input dataset for deployment, as described above in connection with reference number 164 of FIG. 1D. As an example, the data test system 210 may transmit an approval instruction to an application repository to cause the application repository to deploy the application to a deployment environment.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for dataset-based application testing, the system comprising:
one or more memories; and
one or more processors, communicatively coupled to the one or more memories, configured to:
receive information identifying an application for testing, wherein the application includes a dataset processing component that receives an input dataset and generates an actual output dataset;
identify an expected output dataset for the application, wherein the expected output dataset is derived separately from the input dataset and is derived separately from a functionality of the dataset processing component;
execute the application on the input dataset to generate the actual output dataset;
generate a data characterization comparing the actual output dataset and the expected output dataset with respect to a set of metrics;
determine that the data characterization passes the application and the input dataset for deployment; and
cause the application to be deployed to a deployment environment based on the data characterization passing the application and the input dataset for deployment.

2. The system of claim 1, wherein the one or more processors, to generate the data characterization, are configured to:
generate the data characterization based on an equivalency between the expected output dataset and the actual output dataset.

3. The system of claim 1, wherein the one or more processors, to generate the data characterization, are configured to:
generate the data characterization based on a logical relationship between the expected output dataset and the actual output dataset.

4. The system of claim 1, wherein the one or more processors, to generate the data characterization, are configured to:
generate the data characterization based on a range of values by which the expected output dataset differs from the actual output dataset.

5. The system of claim 1, wherein the one or more processors, to generate the data characterization, are configured to:
generate the data characterization based on a first statistical distribution of the expected output dataset relative to a second statistical distribution of the actual output dataset.

6. The system of claim 1, wherein the input dataset is a plurality of datasets and the actual output dataset is another plurality of datasets.

7. The system of claim 1, wherein the input dataset is a single dataset and the output dataset is another single dataset.

8. The system of claim 1, wherein the input dataset is a single dataset and the output dataset is a plurality of datasets.

9. A method for dataset-based application testing, comprising:
receiving, by a data test system, information identifying an application for testing, wherein the application includes a dataset processing component that receives an input dataset and generates an actual output dataset;
identifying, by the data test system, an expected output dataset for the application, wherein the expected output dataset is derived separately from the input dataset and is derived separately from a functionality of the dataset processing component;
executing, by the data test system, the application on the input dataset to generate the actual output dataset;
generating, by the data test system, a data characterization comparing the actual output dataset and the expected output dataset with respect to a set of metrics;
determining, by the data test system, whether the data characterization passes the application and the input dataset for deployment; and
transmitting, by the data test system, information indicating whether the data characterization passes the application and input dataset for deployment.

10. The method of claim 9, wherein transmitting the information indicating whether the data characterization passes the application and the input dataset for deployment comprises:
transmitting an indication of an error associated with the application or the input dataset.

11. The method of claim 10, further comprising:
receiving an update to the input dataset or the application;
re-characterizing the application and the input dataset based on receiving the update; and
transmitting updated information indicating whether the application and the input dataset are to be deployed based on re-characterizing the application and the input dataset.

12. The method of claim 9, further comprising:
storing a log of the information indicating whether the data characterization passes the application and the input dataset for deployment.

13. The method of claim 12, further comprising:
monitoring operation of the application after deployment of the application;
detecting an event associated with operation of the application;
comparing one or more outputs of the application with the log of the information; and
performing an application management action based on a result of comparing the one or more outputs of the application with the log of the information.

14. The method of claim 9, wherein the input dataset includes synthetic or artificial data.

15. The method of claim 9, further comprising:
generating the input dataset to include one or more outlier values associated with a set of test cases; and
wherein generating the data characterization comprises:
generating the data characterization based on the set of test cases.

16. A non-transitory computer-readable medium storing a set of instructions, the set of instructions comprising:
one or more instructions that, when executed by one or more processors of a system, cause the system to:
receive information identifying an application for testing, wherein the application includes a dataset processing component that receives an input dataset and generates an actual output dataset;
identify an expected output dataset for the application, wherein the expected output dataset is derived separately from the input dataset and is derived separately from a functionality of the dataset processing component;
execute the application on the input dataset to generate the actual output dataset;
generate a data characterization comparing the actual output dataset and the expected output dataset with respect to a set of metrics;
determine whether the data characterization passes the application and the input dataset for deployment; and
selectively perform a deployment action on the application based on whether the data characterization passes the application and the input dataset for deployment.

17. The non-transitory computer-readable medium of claim 16, wherein the one or more instructions, that cause the system to configure to generate the data characterization, cause the system to:
generate the data characterization based on at least one of:
an equivalency between the expected output dataset and the actual output dataset,
a logical relationship between the expected output dataset and the actual output dataset,
a range of values by which the expected output dataset differs from the actual output dataset, or
a first statistical distribution of the expected output dataset relative to a second statistical distribution of the actual output dataset.

18. The non-transitory computer-readable medium of claim 16, wherein the input dataset maps to the output dataset on at least one of:
a one-to-one basis,
a one-to-many basis,
a many-to-many basis, or
a many-to-one basis.

19. The non-transitory computer-readable medium of claim 16, wherein the one or more instructions, when executed by the one or more processors, cause the one or more processors to:
store a log of the information indicating whether the data characterization passes the application and the input dataset for deployment.

20. The non-transitory computer-readable medium of claim 16, wherein the input dataset includes synthetic or artificial data.
